(19) United States
(12) Patent Application Publication
(10) Pub. No.: US 2010/0126786 A1
(43) Pub. Date: May 27, 2010

(54) ELECTRIC DRIVE INERTIA RATIO FOR TTT

(75) Inventors: Eric D. Stemler, Peoria, IL (US); Michael E. Vanderham, East Peoria, IL (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/277,805

(22) Filed: Nov. 25, 2008

(51) Int. Cl. B60K 1/00; B62D 55/00; B23P 11/00

(52) U.S. Cl. 180/9.1; 180/65.1; 29/428

(57) ABSTRACT

An electric powertrain, a vehicle using an electric powertrain, and a method of manufacturing a vehicle having an electric powertrain are disclosed. The electric powertrain balances the ability of the vehicle to accept a given load, while at the same time affording the vehicle with an acceptable level of maneuverability. By selectively sizing the ratio of the inertia of the electric motor to the inertia of the vehicle, the optimum balance between these two competing concerns may be reached. Moreover, by optionally ensuring the Stemler Factor is less than or equal to the inertia ratio, the proper balance between load acceptance and maneuverability is attained as well.

### TECHNICAL FIELD

The present disclosure generally relates to electric powertrains, and more particularly relates to an apparatus and method for optimizing the load acceptance and maneuverability of a vehicle employing an electric powertrain.

### BACKGROUND

Many vehicles used in construction, agriculture and industry employ a track-type form of locomotion. More specifically, the engine of the vehicle is coupled to a transmission that drives a rotating sprocket. An endless loop of track is trained around the sprocket and a plurality of idlers in the undercarriage of the vehicle, such that rotation of the sprocket causes rotation of the track. The track is formed from a plurality of shoes hingedly pinned together, with each shoe having a radially outwardly extending grouser for engaging the ground and providing traction. Accordingly, upon rotation of the sprocket, the track rotates around the undercarriage and the vehicle is propelled.

The power for such locomotion is typically provided by an internal combustion engine, more specifically a diesel-type internal combustion engine. Such engines provide extremely high torque at low ground speeds and thus are able to accept loads of substantial size. As the load increases, for example if the track-type tractor is grading soil, pushing gravel, or the like, the engine speed is simply increased to accommodate the load and meet the torque demand.

While effective, such engines run on diesel fuel and thus increased engine speed increases fuel consumption, adding to the cost of operation while at the same time increasing emissions. With the ever rising cost of fuel, and increasing environmental demands of the public and of governmental regulations regarding emissions, such reliance on diesel engines for use in tractors is becoming increasingly unacceptable.

In an effort to abate these concerns, track-type tractors have been developed which use electric motors and powertrains in combination with internal combustion engines. US Patent Publication No. 2007/0080236 is one example of such technology. In the '236 application, an internal combustion engine is coupled to a generator which in turn is coupled to one or more electric motors. The motors are potentially able to provide added torque to the powertrain, but do so without consuming additional fuel or releasing additional emissions. A control circuit is also provided to store the energy provided by the generator when the motor or motors are not being employed, or when the electric motors are being employed in a regenerative braking capacity and thus producing energy.

While such an electric powertrain and tractor are significant advancements in the field, such powertrains continue to be improved, with one current focus being directed toward optimizing the balance between the ability of the tractor to accept and handle a given load, while at the same time providing the tractor with acceptable maneuverability. More specifically, while generally large mass motors can be used to provide the desired level of torque for load acceptance, as the mass and therefore inertia of the motor increases, the ability of that motor to start and stop quickly decreases. This relationship necessarily means that larger mass motors, and track-type tractors employing such motors, have a lessened ability to start, stop, and reverse direction quickly.

One potential solution has been thought to provide low mass/low inertia motors on such vehicles. Such motors can more quickly start, stop and reverse direction. As such vehicles are often called upon to repeatedly push matter forward, reverse direction, and then push forward again and again, this is potentially advantageous. However, the assignee has learned that while low mass or inertia motors do allow for such improved maneuverability, they come at the cost of decreased load acceptance. In other words, such low mass motors are often unable to provide sufficient torque to meet the demands of the load. This can directly translate to track slippage and thus reduced productivity.

### SUMMARY OF THE DISCLOSURE

In accordance with one aspect of the disclosure, an electric powertrain is provided which may include an electric motor having an inertia, and a driven member operatively coupled to the electric motor. The driven member has an inertia and the ratio of the motor inertia to the driven member inertia may be between about 1 and about 2.5.

In accordance with another aspect of the disclosure, a track-type tractor is disclosed which may include a main frame, an electric motor, a gear reduction assembly, and a track. The electric motor is mounted to the main frame and includes a rotor having a mass. The gear reduction assembly is operatively coupled to the electric motor and includes an overall gear reduction ratio. The mass of the rotor multiplied by the square of the overall gear reduction ratio of the gear reduction assembly produces the inertia of the motor. The track is operatively coupled to the gear reduction assembly and has a rolling radius. The track-type tractor includes a total mass. The total mass of the track-type tractor multiplied by the square of the rolling radius of the track produces an inertia of the tractor. The ratio of the motor inertia to the tractor inertia may be within the range of about 1 and about 2.5.

In accordance with a still further aspect of the disclosure, a method of manufacturing a track-type tractor is provided which may include operatively coupling an electric motor to a gear reduction assembly wherein the electric motor and gear reduction assembly have a motor inertia, operatively coupling the gear reduction assembly to a track of the track-type tractor wherein the track-type tractor has a tractor inertia, and sizing the electric motor relative to the track-type tractor such that the track-type tractor may have a Stemler Factor less than the ratio of the motor inertia to the tractor inertia.

These and other aspects and features of the present disclosure will become more apparent upon reading the following description when considered in conjunction with the accompanying drawings.

### BRIEF DESCRIPTION OF THE DRAWINGS

FIG. 1 is a side elevational view of an exemplary vehicle employing the teachings of the present disclosure;

FIG. 2 is a schematic block diagram of the vehicle of FIG. 1;

FIG. 3 is a schematic block diagram of the electric powertrain of the vehicle of FIG. 1; and

FIG. 4 is a flowchart depicting a sample sequence of steps which may be practiced in accordance with an exemplary method employing the teachings of the present disclosure.

While the present disclosure is susceptible to various modifications and alternative constructions, certain illustrative embodiments thereof have been shown in the drawings and will be described below in detail. It should be understood, however, that there is no intention to limit the present disclosure to the specific forms disclosed, but on the contrary, the intention is to cover all modifications, alternative constructions, and equivalents falling within the spirit and scope of the present disclosure.

### DETAILED DESCRIPTION

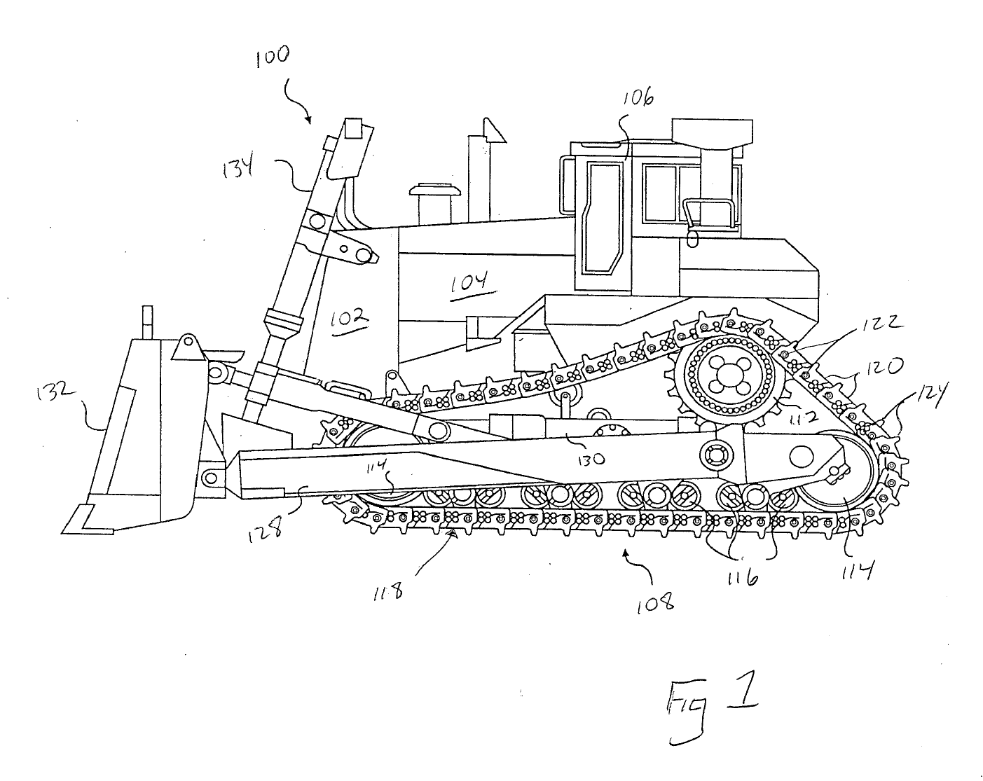

Referring now to the drawings, and with specific reference to FIG. 1, a vehicle constructed in accordance with the present disclosure is generally referred to by reference numeral 100. While the vehicle 100 depicted is a track-type tractor, it is to be understood that the teachings of the present disclosure can be used on any number of different vehicles used in construction, agriculture and industry, including but not limited to bulldozers, farm tractors, graders, skid-steer loaders, front-end loaders, excavators, and the like.

As shown, the vehicle 100 includes a main frame 102 to which an internal combustion engine, or other prime mover or main power source 104 is mounted. The engine 104 may be any known type of engine such as a diesel-type internal combustion engine, a gasoline-type internal combustion engine, natural gas engine, a gas turbine engine, or the like. An operator cab 106 is also provided atop the main frame 102.

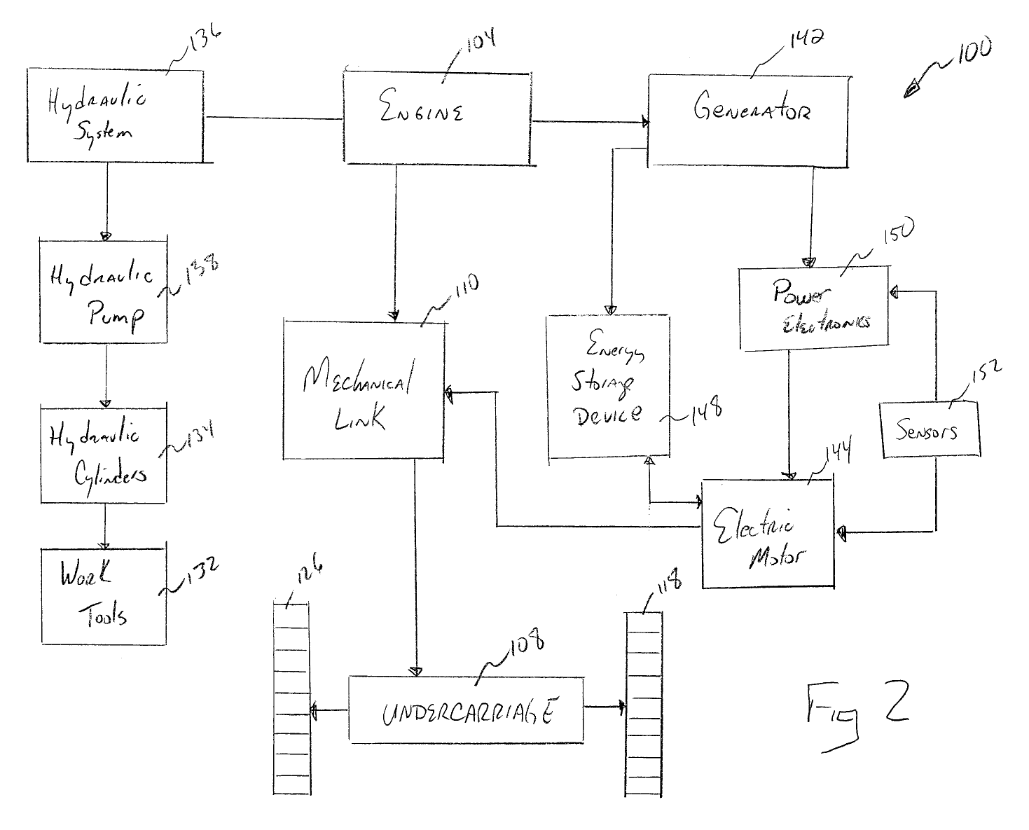

Below the main frame 102, an undercarriage 108 is positioned for propelling the vehicle 100. The undercarriage may be operatively coupled to the engine 104 by a mechanical link 110 (see FIG. 2), such as a transmission, a gear assembly, a differential steering unit or the like. As for the undercarriage 108 itself, it may include a drive sprocket 112, a pair of idler wheels 114, and a plurality of mid-rollers 116, around all of which is trained an endless loop or track 118. The ground-engaging track 118 may include a plurality of shoes 120 hinged together by pins 122. Each shoe 120 may include a grouser 124 for direct engagement into the underlying ground (not shown). Also, as shown in FIG. 2, a second track 126 may be provided on the vehicle 100 in laterally flanking position relative to the first track 118.

Depending on the type of tractor being constructed, the vehicle 100 can then be configured with a number of different implements to perform a given function. For example, with the bulldozer depicted in FIG. 1, the vehicle 100 includes a pair of push arms 128 extending from a roller frame 130 of the vehicle and coupled to a blade 132. In order to lift, tilt, and lower the blade 132, one or more hydraulic cylinders 134 may be connected to the blade 132 and the vehicle 100. The hydraulic cylinders 134 may in turn be connected to a hydraulic system 136 of the vehicle 100 as shown in FIG. 2. Among other things, the hydraulic system 136 may include a pump 138 powered by the engine 104.

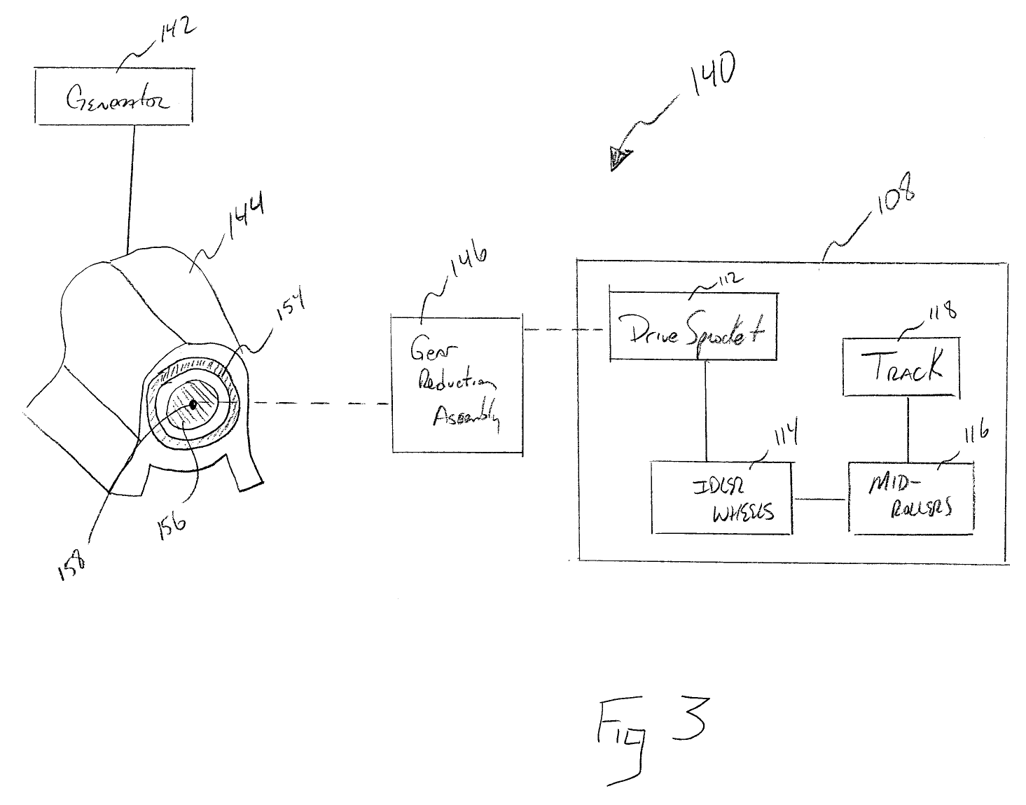

Turning now to FIGS. 2 and 3, the electric powertrain of the present disclosure is generally referred to by reference numeral 140. As shown schematically therein, the electric powertrain 140 may include a generator 142 operatively coupled to the engine 104 to turn at least a portion of the mechanical energy generated by the engine 104 into electrical energy. The generator 142 is then in turn operatively coupled to one or more electric motors 144. The electric motors 144 may be operatively coupled to a gear reduction assembly 146 which is in turn connected to the drive sprocket 110. The gear reduction assembly 146 may include any number of different gearing arrangements and components to step the speed of the motor 144 down to a more useable speed and torque for use by the drive sprocket 112. Such arrangements may include, but not be limited to, planetary gear systems. The gear reduction assembly will also have an overall gear reduction ratio as more fully described below.

As the electric motors 144 may be employed by the vehicle 100 in dynamic fashion, an energy storage device 148 may be used to store the electric energy created by the generator 142 for subsequent use. The energy storage device 148 may be a battery, a capacitor, a flywheel, or any other known type. In addition, the energy created by the motor 144 when run in reverse, such as by regenerative braking, can also be stored in the energy storage device 148.

The type of electric motor 144 employed has no bearing on the relationships and equations referenced herein and may be any known type including, but not limited to, AC, DC, permanent magnet, induction, switched-reluctance, hybrid combination, sealed, brushless, and/or liquid cooled. Similarly, the generator may be any known type including, but not limited to AC, DC, permanent magnet, induction, switched-reluctance, hybrid combination, sealed, brushless, and/or liquid cooled. The motor 144 and generator 142 may be controlled by power electronics or motor drives 150 with one or more speed, torque or other sensors 152 being operatively associated with the motor 144 or generator 142 to provide a closed loop feedback control. In additional, while not germane to the focus of this disclosure, for the purpose of completeness, it is helpful to understand that the power electronics 150 may include a power converter, an inverter controller, and/or motor software, and may be configured to convert and control electricity, for example, provided to the electric motor 144, thereby providing control of speed and torque for the propulsion of the vehicle 100. The power electronics 150 may be housed in a compartment (not shown), which may be sealed and liquid cooled.

In order to provide the vehicle 100 with the optimum balance between load acceptance and maneuverability, the inventors have devised a ratio that enables an electric powertrain to be sized relative to the vehicle. The ratio concerns the inertia of the motor or motors to the inertia of the vehicle. More specifically, the ratio is summarized as follows:
If

Iₘₛ=Iₘ*(GRₜ)², and

Iᵥ=mᵥ*(rrₜ)²),
then

1≦Iₘₛ/Iᵥ≦2.5,
where,
   Iₘₛ is the inertia of the motor at the sprocket,
   Iₘ is the inertia of the motor,
   GRᵣ is the overall gear reduction ratio,
   Iᵥ is the inertia of the vehicle,
   mᵥ is the total mass of the vehicle, and
   rrₜ is the rolling radius of the track.

While a target inertia ratio of about 1.8 has been identified as the optimum balance enabling the vehicle to handle a load while at the same time providing exceptional maneuverability, the inventors have identified ranges of ratios which have heretofore been unknown and which provide an advantageous balance of such concerns. For example, a ratio within the range of about unity (1) to about 2.5 affords the vehicle with such a balance. Within that range, subsets have also been identified which, depending on the particular application of the vehicle may provide optimal performance. In other words, depending on whether the vehicle is a front-end loader, a skid-steer loader, an excavator, a grader, a back-hoe, a farm tractor, or the like, ranges of about 1.3 to about 2.3, about 1.5 to about 2.1, or about 1.7 to about 1.9, among others, may be advantageously employed. As used herein with respect to a numerical value, “about” means within plus or minus ten percent of the stated value.

By way of example, if the vehicle 100 is a bulldozer, load acceptance may be more desirable than maneuverability. In such a case, the manufacturer may size the motor(s) 144 to have a target inertia ratio toward the high end of 2.5. Conversely, if the vehicle 100 is a skid-steer loader or forklift, the maneuverability to start, stop and reverse directions with relatively smaller loads may be more desirable than load acceptance, in which case the manufacturer can size the motor(s) 144 such that the resulting target inertia ratio is more toward the low end of 1.0. Of course, target inertia ratios below 1.0 and above 2.5 are possible as well, and encompassed within this disclosure, but such a range has been identified by the inventors as optimal to avoid track slippage, improve productivity, decrease fuel consumption, enhance load acceptance, and optimize maneuverability.

In arriving at these uniquely identified ratios, the inventors have also derived a relationship between motor torque and inertia ratio that has been previously unknown and which enables manufacturers to size an electric motor and gear reduction assembly to a given vehicle to ensure the proper balance between the load acceptance and maneuverability concerns mentioned above. This relationship, referred to as the Stemler Factor (S_{f}), is represented by the following formulae:

S_{f}=Fₘ*rrₜ*(1/e_{g})*(1/Tₘ),
where:
   Fₘ=the stall pull of the motor,
   rrₜ=the rolling radius of the track,
   e_{g}=the mechanical efficiency of the gear reduction assembly, and
   Tₘ=the motor torque.

To calculate the stall pull (F), the following calculation is made:

F=Tₘ*N*GRᵣ*(1/rrₜ),
where:
   N=the number of motors in the vehicle powertrain, and the remaining variables are defined as set forth above.

Using the above calculations, the inventors have identified that the electric motor and gear reduction assembly should be sized relative to the vehicle employing the motor such that the Stemler Factor is maintained at a level less than or equal to the target inertia ratio mentioned above. If the Stemler Factor is so managed, the optimal balance between load acceptance and vehicular maneuverability can be attained.

### INDUSTRIAL APPLICABILITY

The disclosed powertrain or powertrain may be applicable to any machine used in construction, farming, or industry such as, for example, vehicles having ground engaging tracks. Such track-type vehicles may be, but are not limited to, bulldozers, front-end loaders, graders, skid-steer loaders, and the like. By virtue of using an electric powertrain, exhaust emissions are reduced and fuel efficiency may be increased. In addition, but virtue of the unique optimization disclosed herein, a proper balance between load acceptance and maneuverability in such vehicles is attained leading to less track slippage and improved productivity. The operation of such a vehicle and optimization method will now be explained.

One exemplary application in which the teachings of this disclosure may be employed is in the manufacture of a track-type tractor. In order to reduce fuel consumption and limit emissions that may result from such combustion, it may be desirable to manufacture a track-type tractor with a powertrain which at least in part utilizes electric motors. However, sizing such motors relative to the vehicle to provide both load acceptance and maneuverability has proven, until now, to be challenging to the industry.

The vehicle of the present disclosure is able to do so. Such a vehicle 100 is shown in FIGS. 1-3. As shown, the vehicle 100 may include a main frame 102 to which a prime mover or power source 104 is provided such as a diesel-type internal combustion engine. The engine 104 may be used for a number of different things, including but not limited to driving a mechanically driven transmission 110 operatively coupled to the drive sprocket 112, which in turn is operatively coupled to the track 118 identified above. The engine 104 may also be used to power the pump 138 of the hydraulic system 136 to drive the various hydraulic cylinders 134 on the vehicle 100 used to lift, lower, tilt, or otherwise move the work tools, e.g. the blade 132, provided on the vehicle 100.

One other function the engine 104 may perform is to power the generator 142. As discussed above the generator 142 converts at least a portion of the mechanical energy created by the engine 104 into electrical energy. This electrical energy may then be used to operate the one or more electric motors 144 on the vehicle 100 provided as part of the electric powertrain 140. Each motor 144 may include a stator 154 and rotor 156 as is conventional, with a drive shaft 158 extending from the center of the rotor 156. The drive shaft 158 may then be operatively coupled to the gear reduction assembly 146 to step the relative rotational speed of the motor 144 down to a speed usable by the drive sprocket 112. In so doing, the locomotion of the vehicle 100 can be aided by the electric motors 144 when desired. Moreover, when the electric motors 144 are not in use, the electric energy created by the generator 142 can be stored in an electric energy storage device 148 such as a battery, capacitor, flywheel, or the like, so that when the motor 144 is to be employed, this reserved energy can be utilized, thereby allowing the engine 104 to run slower, use less fuel, and release fewer emissions.

However, without the contributions of this disclosure, the proper sizing of the electric motor or motors in such a vehicle would not be possible. The inventors have derived a series of calculations and relationships between the size and torque of the motor to the size and application of the vehicle which enable manufacturers to optimize the ability of the vehicle to both accept the load confronted in the application, while at the same time providing the vehicle with exceptional maneuverability. The following is one exemplary set of such calculations and decisions which can be made in accordance with the method of this disclosure.

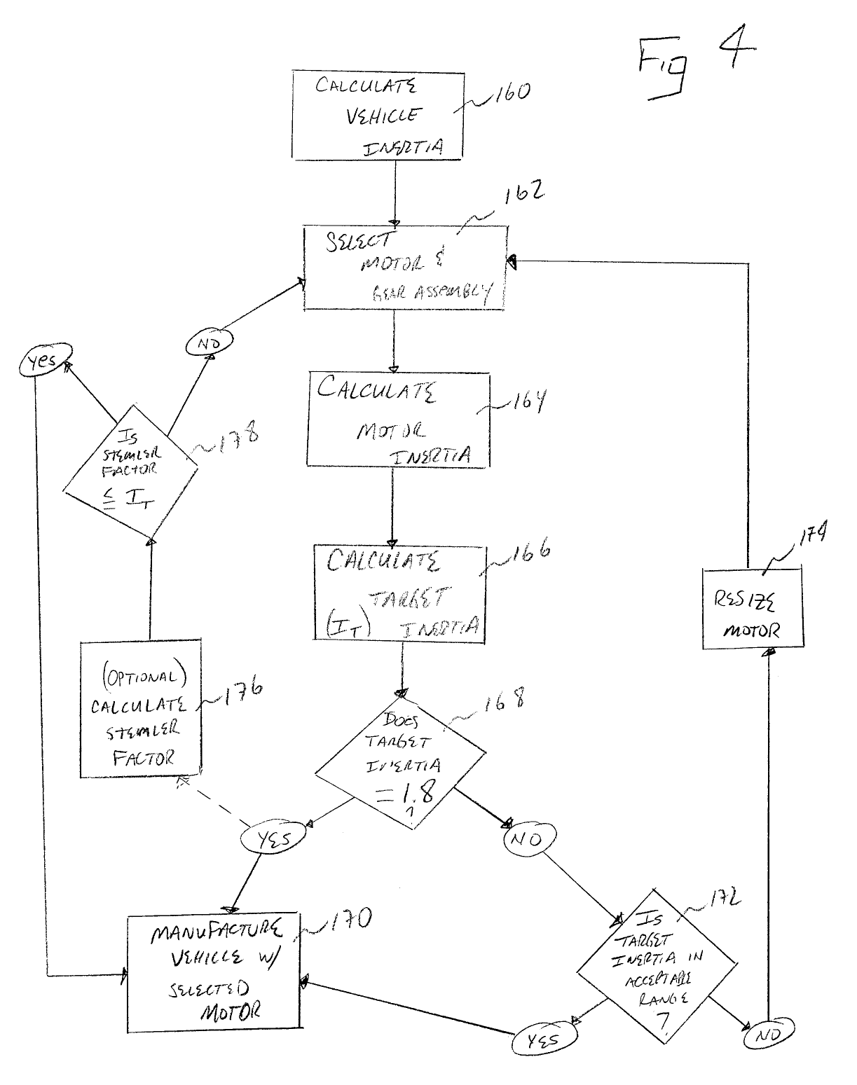

Referring now to FIG. 4, a first calculation may be to calculate the inertia of the vehicle 100 in question. This is represented by calculation 160 in FIG. 4, and is arrived at by multiplying the entire mass of the vehicle 100 by the square of the rolling radius of the track 118. Once the inertia of the vehicle 100 in question is known, the manufacturer will know what the inertia of the motor 144 to be selected should be because the optimum ratio of motor inertia to vehicle inertia has been identified as about 1.8. Using the above equation for motor inertia, the manufacturer can then select a motor 144 and gear reduction assembly 146 (see step 162 in FIG. 4) that ensure that ratio is about 1.8. More specifically, as shown by calculation 164 in FIG. 4, the mass of the motor rotor 156 may be multiplied by the overall gear reduction ratio of the gear reduction assembly 146 to arrive at the motor inertia. That motor inertia can then be divided by the vehicle inertia to arrive at the target inertia ratio. As shown by decision 168, if the target inertia ratio is about 1.8, the selected motor 144 and gear reduction assembly 146 may be used with the vehicle 100 in question to provide the optimum balance between load acceptance and maneuverability as shown by step 170.

If not, the manufacturer can decide if the target inertia ratio is within an acceptable range for the particular type of vehicle being sized as shown by step 172. As identified above, that range may be between about 1 and about 2.5, and depending on the particular application for the vehicle (e.g., bulldozer vs. skid steer loader), the calculated target inertia ratio may be acceptable. If it is, the motor 144 can be used as shown by step 170. If it is above or below that range however, the manufacturer may choose to revert back to step 162 and select a different motor size and/or gear reduction assembly as shown by step 174. Of course, the foregoing is but one sequence of calculations which may be made in accordance with this disclosure. For example, the inertia of the vehicle 100 need not be calculated first, but rather the inertia of the motor 144 could be calculated first with the inertia of the vehicle 100 then being selected to achieve the targeted inertia ratio.

As a further step to ensure the optimum balance is achieved, the manufacturer may also employ the Stemler Factor. As shown in FIG. 4, either in addition to calculating the target inertia ratio, or independent of the target inertia ratio, the Stemler Factor for a particular motor 144 and vehicle 100 combination can be calculated as shown in step 176. If done concurrent with the target inertia ratio, once the target inertia ratio is known, the Stemler Factor dictates that it should be less than or equal to that target inertia ratio. In other words, if the target inertia ratio is calculated to be 1.8, the Stemler Factor of the combination should he less than or equal to 1.8 as well.

Referring in part to the above equations, that Stemler Factor is calculated by multiplying the stall pull of the motor 144 by the rolling radius of the track 118 by the inverse of the gear reduction assembly efficiency by the inverse of the motor torque. The stall pull used in that calculation may be arrived at by multiplying the motor torque by the number of motors 144 in the electric powertrain 140 by the inverse of the rolling radius. If the Stemler Factor is less than the target inertia ratio as determined by decision 178, the manufacturer can use the selected motor 144 (see step 170) and be even more assured that motor 144 and gear reduction assembly 146 have been properly selected for the given vehicle to ensure the optimum balance between load acceptance and maneuverability is reached. If not, the motor can be reselected and the process reverted back to step 162.

Since the optimum target inertia ratio is within the range of about 1 to about 2.5, and the Stemler Factor should be less than or equal to the target inertia ratio, the Stemler Factor should be within the range of about 0.9 to about 2.5. The inventors have found a Stemler Factor of about 1.7 for a motor and vehicle combination having a target inertia ratio of about 1.8 to be optimal. Again, however, similar to the target inertia ratio, depending on the intended environment and application for the vehicle, other values may be acceptable, with exemplary Stemler Factors being within ranges such as about 1.5 to about 1.9, about 1.3 to about 2.1, and about 1.1 to about 2.3.

Based on the foregoing, it can be seen that the present disclosure sets forth an electric powertrain, a vehicle such as a track-type tractor, and a method of manufacturing a track-type tractor with an optimized balance between load acceptance and maneuverability. By properly sizing the motor and gear reduction assembly relative to a given vehicle these competing interests can be balanced, and by employing the unique, previously unknown relationships identified by the inventors and quantified herein, that balance and improved productivity for the vehicle can be attained.

What is claimed is:

1. A powertrain, comprising:
an electric motor having an inertia; and
a driven member operatively coupled to the electric motor, the driven member having all inertia, the ratio of the motor inertia to the driven member inertia being within the range of about 1 to about 2.5.

2. The powertrain of claim 1, wherein the ratio of the motor inertia to the driven member inertia is within the range of about 1.3 to about 2.3.

3. The powertrain of claim 1, wherein the ratio of the motor inertia to the driven member inertia is within the range of about 1.5 to about 2.1.

4. The powertrain of claim 1, wherein the ratio of the motor inertia to the driven member inertia is within the range of about 1.7 to about 1.9.

5. The powertrain of claim 1, wherein the ratio of the motor inertia to the driven member inertia is about 1.8.

6. The powertrain of claim 1, wherein the driven member is a track-type tractor.

7. The powertrain of claim 6, wherein the motor includes a rotor and the powertrain further includes a gear reduction assembly operatively coupled to the rotor, the gear reduction assembly having an overall gear reduction ratio, the motor inertia being equal to the mass of the rotor multiplied by the square of the overall gear reduction ratio of the gear reduction assembly.

8. The powertrain of claim 7, wherein the track-type tractor includes a rotatable track having a rolling radius, the track is operatively coupled to the gear reduction assembly to propel the track-type tractor, and the driven member inertia is equal to the mass of the track-type tractor multiplied by the square of the track rolling radius.

9. A track-type tractor, comprising:
a main frame;
an electric motor mounted to the main frame, the motor having a rotor, the rotor having a mass;
a gear reduction assembly operatively coupled to the electric motor, the gear reduction assembly having an overall gear reduction ratio, the mass of the rotor multiplied by the square of the overall gear reduction ratio of the gear reduction assembly producing the inertia of the motor; and
a track operatively coupled to the gear reduction assembly and having a rolling radius, the track-type tractor having a total mass, the total mass of the track-type tractor multiplied by the square of the rolling radius of the track producing an inertia of the tractor, the ratio of the inertia of the motor to the inertia of the tractor being with the range of about 1 to about 2.5.

10. The track-type tractor of claim 9, wherein the ratio of the inertia of the motor to the inertia of the tractor is within the range of about 1.3 to about 2.3.

11. The track-type tractor of claim 9, wherein the ratio of the inertia of the motor to the inertia of the tractor is within the range of about 1.5 to about 2.1.

12. The track-type tractor of claim 9, wherein the ratio of the inertia of the motor to the inertia of the tractor is within the range of about 1.7 to about 1.9.

13. The track-type tractor of claim 9, wherein the ratio of the inertia of the motor to the inertia of the tractor is about 1.8.

14. A method of manufacturing a track-type tractor, comprising:
operatively coupling an electric motor to a gear reduction assembly, the electric motor and gear reduction assembly having a motor inertia;
operatively coupling the gear reduction assembly to a track of the track-type tractor, the track-type tractor having a tractor inertia; and
sizing the electric motor relative to the track-type tractor such that the track-type tractor has a Stemler Factor less than the ratio of the motor inertia to the tractor inertia.

15. The method of manufacturing a track-type tractor of claim 14, wherein the electric motor is sized relative to the track-type tractor such that the Stemler Factor is within the range of about 0.9 to about 2.5.

16. The method of manufacturing a track-type tractor of claim 14, wherein the electric motor is sized relative to the track-type tractor such that the Stemler Factor is within the range of about 1.4 to about 2.0.

17. The method of manufacturing a track-type tractor of claim 14, wherein the electric motor is sized relative to the track-type tractor such that the Stemler Factor is within the range of about 1.6 to about 1.8.

18. The method of manufacturing a track-type tractor of claim 14, wherein the electric motor is sized relative to the track-type tractor such that the Stemler Factor is about 1.7.

19. The method of manufacturing a track-type tractor of claim 14, wherein the tractor has a stall pull, the track has a rolling radius, the gear reduction assembly has an efficiency, and the electric motor has a torque, and wherein the Stemler Factor is calculated by multiplying the stall pull by the rolling radius, the inverse of the gear reduction assembly efficiency, and the inverse of the motor torque.

20. The method of manufacturing a track-type tractor of claim 19, wherein the stall pull of the Stemler Factor is calculated by multiplying the motor torque by the number of motors on the track-type tractor, by the gear reduction assembly efficiency, and by the inverse of the rolling radius.
